(19) United States
(12) Patent Application Publication
(10) Pub. No.: US 2008/0319886 A1
(43) Pub. Date: Dec. 25, 2008

(54) Winans Trend Indicator

(76) Inventor: Kenneth G. Winans, Novato, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/767,880

(22) Filed: Jun. 25, 2007

(51) Int. Cl. G06Q 40/00

(52) U.S. Cl. 705/35

(57) ABSTRACT

Two moving averages are plotted against a market index price to signal long term market trends. To avoid whipsaws, when applied to the S&P 500, the 40 week moving average is given a negative 3.6% filter and the 25 week moving average is given a positive 2% filter. Crossings of the moving averages are ignored. An index price dipping below the negative 3.6% filter of the 40 week moving average will generate a sell signal and an index price rising above the 2% filter over the 25 week moving average will generate a buy signal. A related moving average fund buys and sells financial instruments based upon the methods of disclosed system, know as Winans Trend Indicator.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) Field of the Invention

Generally, the invention relates to means and methods of tracking and predicting trends in financial markets. More particularly, the invention relates to the use of multiple moving averages and asymmetric filters to trigger the purchase and sale of securities. A related moving average fund is also disclosed.

(2) Description of the Related Art

Several attempts to track and/or predict market trends are known in the related art. The study of past financial data is often called “technical analysis”. One of the goals of technical analysis is to identify trends in a market with enough certainty to profitably purchase and sell financial instruments. When a market is perceived as trending downward, or in a “bear” mode, investors will sell. When a market is perceived as trending upward, or in a “bull” mode, investors will buy.

US patent application 20060287945 “Trading system” by Spaccatrosi discloses the use of a slow moving average and a fast moving average to generate trend signals. A purchase signal is triggered when the shorter or faster moving average rises above the slower or longer moving average. A sell signal is triggered when the shorter moving average drops below the longer moving average. In an effort to avoid whipsaw problems or false signals due to short-term market fluctuations, Spaccatrosi discloses a complex system of volatility measurements to dynamically change the number of periods used to construct each moving average. Spaccatrosi also considers the use of Bollinger bands that symmetrically straddle both moving averages by a dynamic span proportional to market volatility. The Bollinger bands provide symmetrical upper and lower ranges to both moving averages that span 4 standard deviations of measured market volatility. Spaccatrosi fails to consider the current position of the measured index and instead, considers the index's moving averages only.

Spaccatrosi fails to disclose a real world solution to predicting market trends and fails to provide a proven record of accomplishment or utility. Spaccatrosi's use of crossing moving averages teaches away from the methods of the present invention, such as the present invention's use of current price crossings with a particular moving average to generate a buy signal and the use of a different moving average to generate a sell signal. Spaccatrosi's unrefined use of Bollinger bands to create both lower and upper limits symmetrically straddling two moving averages teaches away from the present invention's use of a discrete warning track method to provide an upper limit for one moving average and a different lower limit for another moving average.

Spaccatrosi fails to claim or demonstrate any unexpected results or even any favorable results. Investors are still seeking means to “beat the market”. Thus, what is needed in the art are means and methods of using a dual moving average system with a tailored warning track system or filter and other features to provide reliable trend signals.

### BRIEF SUMMARY OF THE INVENTION

The present invention overcomes shortfalls in the related art by disclosing a trend signal system that consistently outperforms the S&P 500. The present invention, sometimes referred to herein as “the invention” or “Winans Trend Indicator” achieves unexpected results when plotted and applied to the S&P 500 and other legitimate indices. When applied to the S&P 500 for the past 56 years, the invention out performs the S&P 500 at an average of 0.6% per year.

The unexpected results of the invention are due, in part, to applying methods that are not anticipated in the related art. Unlike Spaccatrosi, the invention does not dynamically change the periods of the moving averages, but instead, for the S&P 500, uses a static 40 week moving average and a static 25 week moving average. Unlike Spaccatrosi, the invention does not constantly attempt to measure market volatility and does not use Bollinger bands or any variation of Bollinger bands to filter market variations from market trends. Unlike the related art, the invention eschews the conventional wisdom discussed in Spaccatrosi by ignoring the cross over points of moving averages and by not using any dynamic or symmetrical filter system.

While ignoring the traditional metrics of changing volatility, symmetrical Bollinger bands, dynamic moving average periods and the relative positions of moving averages, the present invention was found by trail and error, computer optimization and painstaking review of long term market trends. The invention presents a real world solution to the long felt need of “beating the market”. The invention's acceptance of a greater number of whipsaws in defining buy signals as compared to the number of whipsaws allowed in defining sell signals is a radical departure from the related art's use of Bollinger bands where buy and sell signals are filtered by an equal or symmetrical margin.

In the preferred embodiment, the Friday closing price of the S&P 500 is compared to its 40 week simple moving average for purposes of triggering a sell signal and compared to its 25 week simple moving average for purposes of triggering a buy signal. To avoid premature signals or whipsaws caused by market fluctuations, 3.6% of the value of the 40 week moving average is subtracted to create a lower filter or warning tack and 2% is added to the value of the 25 week moving average to create an upper filter or warning track.

A sell signal is generated if, and only if, the S&P 500 Friday closing index value dips below the lower warning track of the 40 week moving average. Such a dip in index value is most likely indicative of a long-term downward trend. A buy signal is generated if, and only if, the S&P 500 Friday closing index value rises above the upper warning track of the 25 week moving average. Unlike the related art and the trend in the related art, crossing points of the moving averages are not considered. Unlike the related art, the position or movement of the 40 week moving average or longer moving average will never trigger a buy signal and the position of the 25 week moving average or shorter moving average will never trigger a sell signal.

To achieve optimal results in the preferred embodiment, index crossings with a moving average occurring on a Friday close only are considered. In testing the performance and unexpected results of the invention, sell or buy signals generated on a Friday close were not executed until the next Monday or trading day. This testing protocol truthfully simulates market conditions wherein buy or sell orders may be impossible to execute in a volatile market. In testing the invention, when a sell signal was generated, sale proceeds were treated as if placed in U.S. Treasury Bills. In response to the next buy signal, principal and interest amounts from the U.S. Treasury Bills where hypnotically used to purchase index products.

By rejecting the traditional wisdom of “buy and hold” where investors ride out market drops, such as the market drop in 2000 to 2003, the invention gives investors the opportunity to sell their index products or financial instruments and purchase U.S. Treasury instruments or other relatively safe, interest bearing instruments, and thus increase profits in a bear market. After a sell signal from the invention, investors may also engage in short selling or other means to take advantage of a declining market.

The 40 week or 200 day moving average of the S&P 500 is calculated by summing the S&P 500 index values for the past 200 business days and dividing by 200. Such an average is called “moving” as the next day's calculation will delete the 200^{th} day value of the prior calculation and then enter the index value of the current day. The 25 week or 125 day moving average is calculated in a similar fashion. An advantage to the preferred embodiment of the present invention is that the 200 day and 125 day moving average values for the S&P 500 are widely published and widely available. The preferred embodiment does not use any obscure data or difficult calculations and is thus easily tested and used, especially when compared to the elaborate calculations required by Spaccatrosi and the related art.

The invention includes a moving average fund that may be implemented as an ETF or fund of funds or as an open-ended mutual fund where S&P index products, or other index products, may be traded within the disclosed fund based upon the product being priced above or below its moving average.

These and other objects and advantages will be made apparent when considering the following detailed specification when taken in conjunction with the drawings.

### BRIEF DESCRIPTION OF THE DRAWINGS

FIG. 1 is a graph showing price levels of the S&P 500 on the vertical axis and time on the horizontal axis.

FIG. 2 is a table showing calculations triggering action signals, such as none, buy, or sell as further illustrated in boxes 6, 7, and 8 in FIG. 1.

FIG. 3 is a table showing market conditions triggering a buy signal as further illustrated in box 9 on FIG. 1.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. The reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment nor are separate alternative embodiments mutually exclusive of other embodiments.

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, functional, and other changes may be made without departing from the scope of the present invention. The flowing detailed description is, therefore, not to be taken in a limiting sense, and the scope of the present invention is defined only by the appended claims.

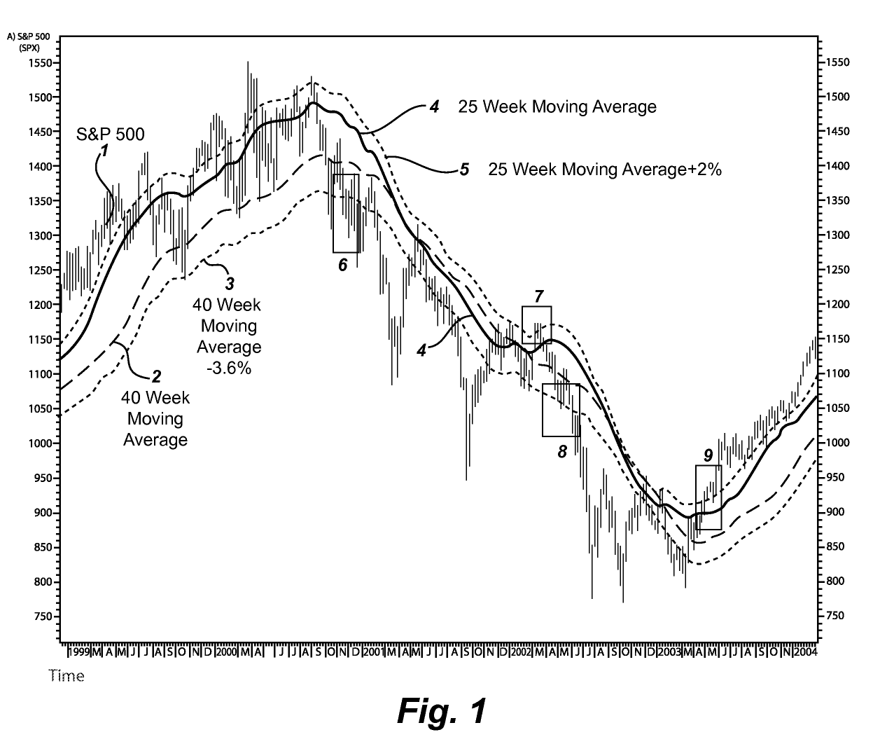

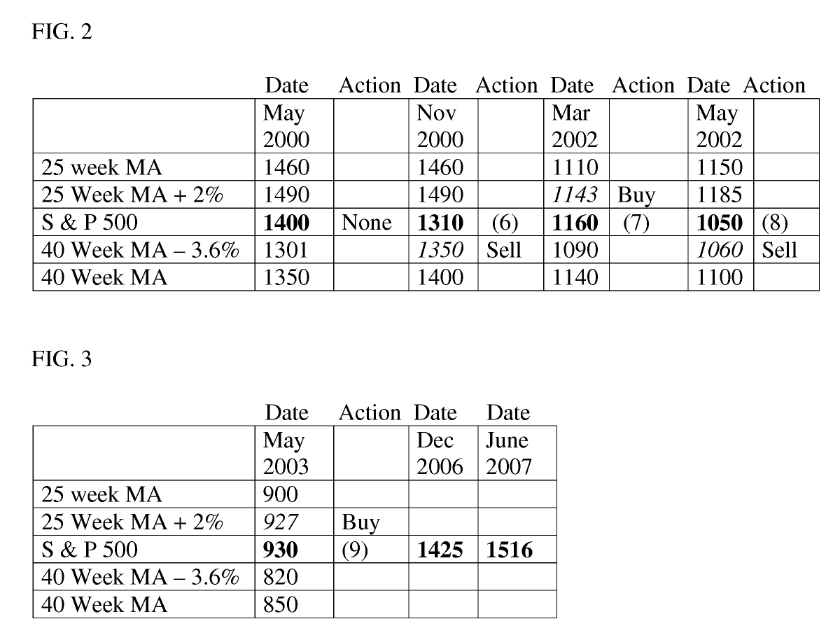

The drawings are not necessarily to scale and in some instances, proportions may have been exaggerated in order to more clearly depict certain features of the invention. The values in the tables of FIG. 2 and FIG. 3 may vary slightly from the values shown graphically in FIG. 1.

FIG. 1 is a graph showing price levels of the S&P 500 on the vertical axis and time on the horizontal axis. The 25 week moving average 4 is shown in a solid line, the 25 week moving average plus 2% warning track 5 is shown in short dashed lines, the 40 week moving average 2 is shown in long dashed lines, and the 40 week moving average minus 3.6% warning track 3 is shown in short dashed lines.

The 25 week or 125 day moving average 4 is sometimes referred to as the shorter or faster moving average. The 40 week or 200 day moving average 2 is sometimes referred to as the longer or slower moving average. The 25 week moving average plus 2% warning track or filter value 5 is sometimes referred to as a buy line. The 40 moving average minus 3.6% warning track or filter value 3 is sometimes referred to as a sell line

Buy Line

The 25 week moving average plus 2% warning track line or value 5 is sometimes referred to herein as the “upper warning track”, “buy line”, or “buy signal”. The buy line is generated by adding 2% to the 25 week moving average 4. In alternative embodiments, a buy line is generated by adding a relatively small percentage to a relatively shorter moving average.

Sell Line

The 40 week moving average minus 3.6% warning track or value 3 is sometimes referred to herein as the “lower warning track”, “sell line”, or “sell signal”. The sell line is generated by subtracting 3.6% from the 40 week moving average 2. In alternative embodiments, a sell line is generated by subtracting a relatively large percentage from a relatively longer moving average.

In order to more efficiently detect upward trends and to accept an optimal number of whipsaws, the buy line is a smaller distance from the 25 week moving average as compared to the sell line margin of 3.6% subtracted from the 40 week moving average. The uneven nature of the buy and sell line margins presents a unique composition that yields unexpected results, such as a quick stop to losses and early detection of upward trends as found in boxes 7, 8, and 9 of FIG. 1 and as further discussed below.

25 Week Moving Average

A relatively shorter moving average is used as a basis to create a buy line. In the preferred embodiment, the S&P 500 125 day high price moving average is used to create the 25 week moving average line 4 found in FIG. 1. This is a simple moving average wherein the highest daily price over the past 125 days is summed and divided by 125. As there are 5 business days in a week, the 125 day moving average is sometimes referred to as the 25 week moving average.

The 25 week moving average 4 may be considered the shorter or faster moving average as compared to the longer or slower 40 week moving average 2. The 25 week moving average will average a fewer number of days than the 40 week moving average and thus is more responsive to price changes. The invention takes advantage of market characteristics by using a shorter moving average to detect upward trends only. The use of the shorter moving average for detecting downward trends would result in the problems currently experienced by the related art such as excessive false signals or whipsaws and failure to achieve results that beat the market or legitimate indices, such as the S&P 500.

A 2% margin is added to the 25 week moving average to lessen and optimize the number of whipsaws triggered in attempting to detect upward trends. As shown in box 7 of FIG. 1, the invention does not remove all whipsaws, which would result in a lower overall performance of the invention and make the invention more akin to the related art. The unique and unobvious combination of using a 25 week simple moving average with a 2% positive margin or filter and cross over of the Friday close S&P 500 to trigger a buy signal only is a key element in achieving the unexpected result of beating the S&P 500 rate of return by an average of 0.6% over the past 56 years.

In alternative embodiments, other indices may be used to create the basis of a buy line by using a fixed moving average period that is shorter than the fixed moving average period used as the basis for a sell line. The shorter fixed moving average will have a relatively smaller margin to create a buy line and the longer fixed moving average will have a relatively larger negative margin to create a sell line.

40 Week Moving Average

The 200 day low price moving average is used as a basis for the selling indicator and comprises the 40 week moving average 2. Box 6 in FIG. 1 encloses a sell signal wherein the S&P 500 Friday close price, FIG. 2, of 1,310 in November 2000 dips below the lower warning track, sell line, or sell value of 1,350. As shown in FIG. 2, the November 2000 sell signal 6 comprises a 40 week moving average value of 1,400. The lower warning track, or sell trigger line value of 1350 is derived by subtracting 3.6% from the 40 week moving average value of 1,400. Unlike the related art, for purposes of triggering a sell signal, the shorter or faster moving average, in this case the 25 week moving average, FIG. 1, 4 and its related buy line value 5 are not considered.

Unexpected Results

Box 7 in FIG. 1 encloses a buy signal wherein the S&P 500 Friday close price, FIG. 2, of 1,160, of March 2002, rises above the value of the 25 week moving average plus 2% warning track or buy line value of 1,132. The upper warning track or buy line 5 value is derived by adding 2% to the 25 week moving average value of 1,110. Unlike the related art and contrary to the teaching of Spaccatrosi, the longer or slower moving average, in this case the 40 week moving average, is not considered in triggering a buy signal.

In the related art, buy signal 7 of March 2002 would be considered an unacceptable whipsaw, since in the S&P 500 did not immediately gain value after March 2002, but instead, suffered a moderate crash, dropping to 780 in July 2002. The invention achieves unexpected results by quickly stopping losses in May 2002 at sell signal 8 at an index value of 1,050. An unexpected advantage of the present invention is the quick recovery from occasional whipsaws, a feature not found in the related art. Sell signal 8 results in a cash out at 1,050 which is then reinvested at buy signal 9 at an index value of 930. A user of the invention could sell short at sell signal 8 or invest sale proceeds in U.S. Treasury Bills or some other safe interest bearing instrument, and thus increase his or her wealth in a declining market. The sale 8 at 1,050 and buy 9 at 930 results in a net gain in the number of index shares and a further increase in the wealth of the user of the invention.

The advantage of owning a greater number of shares and the advantages of the invention are also demonstrated in FIG. 3 by the S&P index price of 1,425 in December 2006 and 1,516 in June 2007. The invention's larger sell filter or margin of 3.6% and exclusive use of the 40 week simple moving average to trigger sell signals only has successfully prevented any damaging whipsaw sales or any sell signal after buy signal 9 of May 2003 to June 2007.

By using techniques opposite to the use of Bollinger bands and the teachings of the related art, the present invention achieves an optimal balance of sensitivity to market conditions, avoidance of excessive whipsaws and quick recovery from whipsaws.

The present invention prevented a loss of 270 points from May 2002 to July 2002 but yet caught the upward trend of May 2003 when the index was at 930. FIG. 3 shows a buy signal 9 occurring in May 2003 wherein the S&P 500 was at 930 or just 3 points above the upper warning track or buy line 5 of 927. The present invention achieved a gain of 495 points from May 2003 as of December 2006 when the S&P 500 was at 1,425. The present invention continues to provide unexpected results as the S&P 500 was at 1,516 on or about June, 2007.

The second column of FIG. 2 shows a no action condition wherein the S&P 500 is 1,400 and below the upper warning track 5 of 1,490 and above the lower warning track 3 of 1,301.

### ALTERNATIVE EMBODIMENTS

The invention is not limited to use with the S&P 500 and is well suited for use in other market indices such as, but not limited to, S&P 400, Russell 2000, Whilshire 5000, and Dow Jones Industrial Average.

In alternative embodiments, a simple moving average of at least 25 days is used as a shorter or faster moving average and as a basis for generating a buy line or buy value. The buy line or buy value is generated by adding 1.5% to 3.0% to the shorter moving average. The shorter moving average and related buy line are used only for triggering a buy signal. When the index value exceeds the buy line, a buy signal is generated.

A longer or slower moving average is used as a basis to generate a sell line or sell value. The longer moving average will average the values of no less than 40 days. The sell value or sell line is generated by subtracting 2.5% to 5.0% from the longer moving average. The longer moving average and related sell line are used only for triggering a sell signal. When the index values is less than the sell line, a sell signal is generated. The longer moving average is preferably 1.4 to 1.7 times larger than the shorter moving average. Friday index closing prices may be considered in generating either a buy or sell signal.

Moving Average Index Fund

The disclosed moving average method of market trend analysis is well suited to construct a moving average fund that may be implemented as an ETF, Exchanged Traded Fund or fund of funds or an open ended mutual fund, or any other investment product. For example, S&P 500 index products such as Standard & Poor's Depositary Receipts, ticker symbol is SPY, may traded within the disclosed moving average index fund based upon SPY being above or below its moving averages as described above.

What is claimed is:

1. A method of signaling upward or downward trends of a financial instrument or index of securities (“index”) comprising the steps of:
a) calculating a shorter or faster moving average using at least 25 days;
b) calculating a longer or slower moving average of at least 40 days;
c) calculating a sell value or sell line by subtracting 2.5% to 5.0% from the longer moving average;
d) calculating a buy value or buy line by adding 1.5% to 3.0% to the shorter moving average;
e) generating a sell signal, if and only if, the index value drops below the sell line; and
f) generating a buy signal, if and only if, the index value rises above the buy line.

2. The method of claim 1 wherein only Friday index closing prices are considered in generating either a buy or sell signal.

3. The method of claim 2 wherein the longer moving average comprises the lowest price for each day and the shorter moving average comprises the highest price of each day.

4. The method of claim 3 wherein the longer moving average is 1.4 to 1.7 times longer than the shorter moving average.

5. The method of claim 4 wherein the longer moving average is 200 days and the shorter moving average is 125 days.

6. A method of using two moving averages to predict price trends in the S&P 500 index comprising the steps of:
a) calculating a longer moving average of 200 days and a shorter moving average of 125 days;
b) adding 2.0% to the shorter moving average to construct a buy line;
c) subtracting 3.6% from the longer moving average to construct a sell line;
d) generating a sell signal if the S&P 500 index dips below the sell line; and
e) generating a buy signal if the S&P 500 index rises above the buy line.

7. The method of claim 6 wherein the 200 day moving average comprises day low prices and the 125 day moving average comprises day high prices.

8. The method of claim 7 wherein the S&P 500 index Friday closing price is compared against the buy and sell line.

9. A method of creating a moving average fund in accordance with the steps of claim 8 and wherein:
a) products selected from the S&P 500 are used to create a 200 day moving average with a 3.6% subtraction to create a sell line and to create a 125 day moving average with a 2.0% addition to create a buy line;
b) when a selected product's price rises above the buy line, the product is purchased; and
c) when a selected product's price dips below the sell line, the product is sold.

10. A method of constructing a moving average fund comprising the steps of:
a) selecting a financial product or a index of products, such as the S&P 500, and for the selected product;
b) calculating a longer moving average of at least 40 days and a shorter moving average of at least 25 days;
c) adding 1.5% to 3.0 percent to the shorter moving average to create a buy line;
d) subtracting 2.5% to 5% from the slower moving average to create a sell line;
e) selling the selected product when the selected product's price dips below the sell line; and
f) buying the selected product when the selected product's price rises above the buy line.

11. The method of claim 10 wherein day low prices are used to calculate the longer moving average and day high prices are used to calculate the shorter moving average.

12. The method of claim 11 wherein the selected product's Friday close price is compared against the product's longer and shorter moving averages for purposes of signaling a sell or buy signal.

13. The method of claim 12 wherein the number of days used to calculate the longer moving average is 1.4 to 1.6 times larger than the number of days used to calculate the shorter moving average.

14. The method of claim 12 wherein 2% is added to the shorter moving average to create a buy line and 3.6% is subtracted from the longer moving average to create a sell line.

15. The method of claim 14 wherein the longer moving average is comprised of 200 days and the shorter moving average is comprised of 125 days.
